(19) United States
(12) Patent Application Publication
(10) Pub. No.: US 2018/0137268 A1
(43) Pub. Date: May 17, 2018

(54) AUTHENTICATION SCREEN

(71) Applicant: CA, Inc., New York, NY (US)

(72) Inventors: Yashwant Ramkishan Sawant, Parbhani (IN); Sandeep Banisetti, Srikakulam (IN); Mohammed Mujeeb Kaladgi, Bangalore (IN); Junaid Ahmed Jameel, Bangalore (IN)

(21) Appl. No.: 15/354,012

(22) Filed: Nov. 17, 2016

(51) Int. Cl. G06F 21/36; G06F 21/31

(52) U.S. Cl. CPC G06F 21/36; G06F 7/582; G06F 21/316

(57) ABSTRACT

Techniques are disclosed relating to authenticating a user via a lock screen. In one embodiment, a computer device presents a two-dimensional matrix of elements on a display of the computing device and detects a continuous gesture performed by a user on the display over the two-dimensional matrix of elements. In some embodiments, the gesture includes a first portion selecting a first set of the elements and a second portion selecting a second set of the elements. In response to detecting the continuous gesture, the computer device authenticates the user based on the selected first set of elements and initiates performance of an action based on the second set of elements such as execution of a particular application, opening a particular file, opening a particular menu of an application, etc.

### BACKGROUND

### Technical Field

This disclosure relates generally to computing devices, and, more specifically, to user authentication.

### Description of the Related Art

Mobile devices, such as smart phones, typically present an authentication screen on a touch-sensitive display in order to allow a user to authenticate prior to granting access to the device. Such a screen may ask a user, for example, to enter a four-digit pin, which is used to establish that a user is authorized to access the device. Once a user has successfully authenticated, the device may present a menu that depicts applications installed on the device. If the user wants to execute a particular application, the user can select the application to cause the mobile device to initiate execution of the application.

### SUMMARY

The present disclosure describes embodiments in which a user is presented with a lock screen that allows the user to authenticate and request performance of an action in response to a successful authentication. In some embodiments, the lock screen is presented to authenticate a user attempting to access a device. In such an embodiment, the user may perform a gesture (e.g., on a touch-sensitive display) to authenticate and extend the gesture to cause a particular application to be opened upon authentication. In one embodiment, the lock screen depicts a group of icons corresponding to applications available for execution, and the user performs the gesture over the icons and extends the gesture to the application to be opened. In some embodiments, the lock screen is presented to authenticate a user attempting to access an application. In such an embodiment, the user may perform a gesture to authenticate and extend the gesture to cause the application to display particular content (e.g., menus, files, data, etc.) responsive to a successful authentication. In some embodiments, the lock screen may be presented on a client device attempting to access a service provided by a server.

### BRIEF DESCRIPTION OF THE DRAWINGS

FIG. 1A is a block diagram illustrating one embodiment of a lock screen using dots.

FIG. 1B is a block diagram illustrating one embodiment of a lock screen using icons.

FIG. 1C is a block diagram illustrating one embodiment of a lock screen using a personal identification number (PIN).

FIG. 2A is a block diagram illustrating one embodiment of a computing device configured to authenticate a user with a lock screen.

FIG. 2B is a block diagram illustrating one embodiment of a system in which a client device interacts with a server system to authenticate a user with a lock screen.

FIG. 3 is a block diagram illustrating one embodiment of a handler executable to present a lock screen for authenticating a user.

FIG. 4 is a flow diagram illustrating one embodiment of a method for unlocking a device and opening an application.

FIGS. 5A and 5B are flow diagrams illustrating embodiments of methods for authenticating a user.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “network interface configured to communicate over a network” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a password that has multiple portions, the terms “first” portion and “second” portion can be used to refer to any portion of a password. In other words, the first and second portions are not limited to the initial two portions of a password.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

As the number of applications available to mobile devices continues to increase, the time required to authenticate and locate a particular application for execution continues to increase. In many instances, a user spends a considerable amount of time navigating through several menus before finding a desired application. Additionally, users often search for different applications throughout a given day and may forget which menu includes a desired application. To assist the user, operating systems on the mobile device may allow a user to directly open an application in response to receiving a notification; however, a user may desire to open that application when no notification has been provided.

The present disclosure describes embodiments in which a user can quickly and efficiently open applications, files, particular menus of an application, etc. from a lock screen used to authenticate a user. As will be described in greater detail below, in various embodiments, a lock screen displays an arrangement of elements (e.g., application icons in some embodiments) that allows a user to perform a gesture connecting the elements to form a passcode. The user may extend this gesture to include one or more additional elements (e.g., an icon of an application to be opened) so that the device or system provides access to the user and opens an application associated with the additional element. In doing so, the user does not have to navigate through several menus looking for an application after unlocking the device or system.

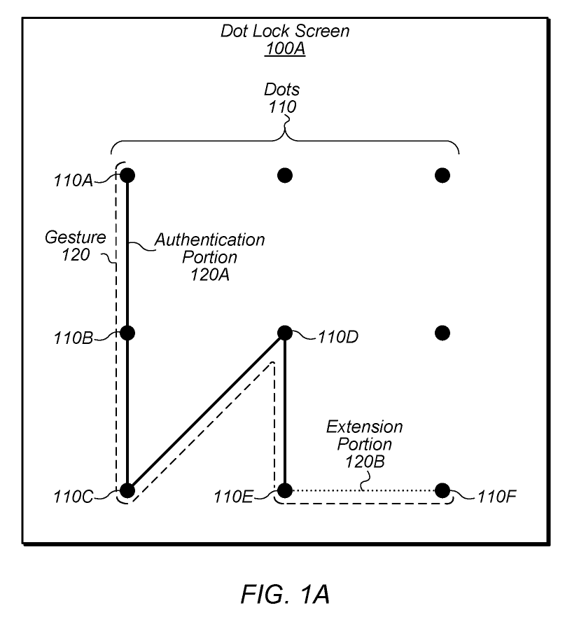

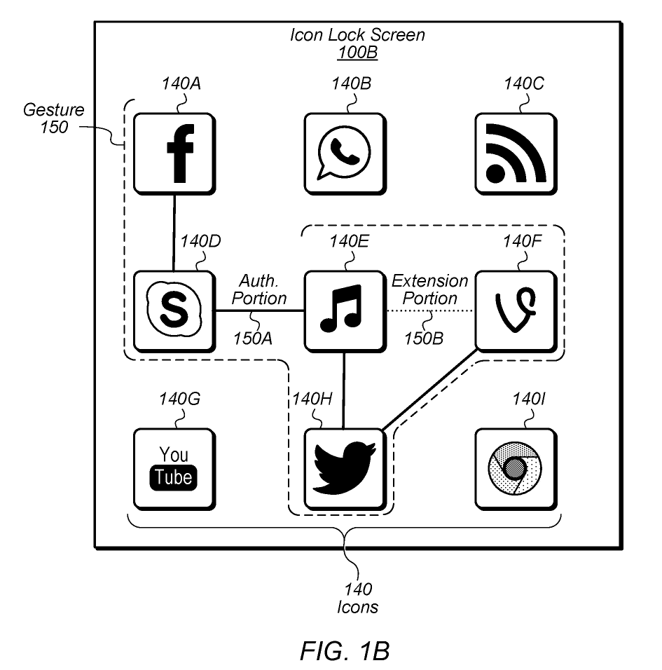

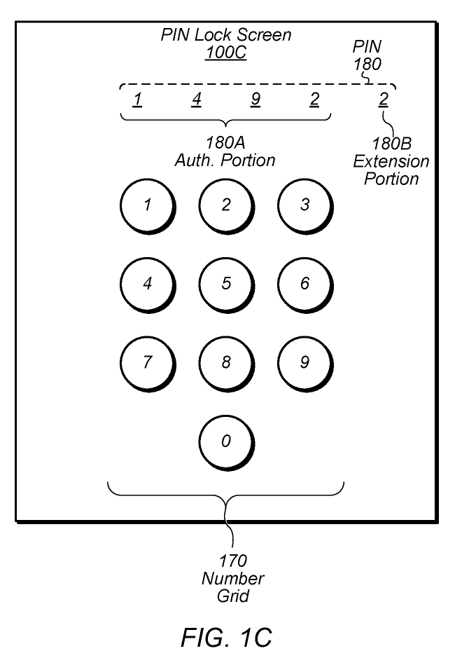

Turning now to FIG. 1A, a block diagram of a dot lock screen 100A is depicted. In some embodiments, lock screen 100A may be presented as a screen for authenticating a user attempting to access a computing device—e.g., unlocking a smartphone. In other embodiments, screen 100A may be presented to authenticate a user attempting to access content in an application executing on a computing device or another device—e.g., a user attempting to pull up an account balance menu in a banking application. In the illustrated embodiment, lock screen 100A includes a matrix/grid of dots 110 over which a user can perform a gesture 120 connecting a subset of the dots 110 (e.g., dots 110A-F shown in FIG. 1A). As shown, this gesture 120 may include an authentication portion 120A and an extension portion 120B.

Authentication portion 120A, in one embodiment, is a portion of gesture 120 used to authenticate a user. Accordingly, when a user account is initially created, the user may be asked to perform an initial gesture, which serves as a user's passcode/password and is stored in memory in order to verify subsequent access requests. In embodiments in which screen 100A is presented on a touch-sensitive display, the user may perform this gesture by dragging a finger on the display while maintaining continuous pressure on the display throughout the gesture. For example, in FIG. 1A, a user places a finger starting at dot 110A and moves the finger thorough dots 110B-110E without lifting the finger. As a user performs a gesture 120, this may be reflected on screen 110A with connections being placed between dots 110. When a user later wants to authenticate, a user may perform gesture portion 120A again, which may be compared against previously stored information identifying gesture portion 120A in order to verify the user's identity. In various embodiments, if the user were to stop at this point (i.e., not perform extension portion 120B), the user is presented with a default screen displayed after authentication. For example, if a user is unlocking a computing device, the user may be presented with a home screen having a menu of available applications for execution. If a user is attempting to log into an application, the user may be present with a default initial screen that appears after login. As shown in FIG. 1A, however, the user may alternatively choose to extend the gesture 120 by performing an extension portion 120B.

Extension portion 120B, in one embodiment, is an extension of a gesture 120 that is used to convey an instruction for what is to occur upon a user being successfully authenticated. In an embodiment in which a touch-sensitive display is used, extension portion 120B may be performed by continuing to maintain pressure on the display after performance of authentication portion 120A and moving the finger on to one or more additional dots 110 such that portions 120A and 120B form a single contiguous gesture. As noted above, in some embodiments, extension portion 120B may be used to open a particular application, a particular file, a particular menu within an application, etc. In various embodiments, the manner in which extension portion 120B is performed controls which action is performed responsive to portion 120B. For example, if screen 100A is a screen for unlocking a smartphone, dot 110A may be associated with opening the Twitter™ application stored in the smartphone while dot 110F may be associated with opening the Facebook™ application. Thus, selecting dot 110F as shown in FIG. 1A may result in opening the Facebook™ application upon authentication. In various embodiments, the particular actions performed responsive to an extension portion 120B may be defined by a user. For example, if screen 100A is being used as a login screen for a device, a user might define performing an extension portion 120B to dot 110D as opening a particular file and performing an extension portion 120B to dot 110F as opening a music application. An another example, if screen 100A is used as a login screen for an application, the user may select particular menus or particular content to be displayed when particular extension portions 120B are performed. Although extension portion 120B is shown in FIG. 1A as being appended to the end of gesture 120, extension portion 120B may located at the beginning of gesture 120 or even overlap with authentication portion 120A in other embodiments.

In some embodiments, screen 100A may also be implemented differently than shown in FIG. 1A. Accordingly, more (or less) dots 110 may be included. The matrix of dots 110 may have an arrangement other than a square such as a triangle, circle, rectangle, etc. Elements other than dots 110 may be depicted on screen 100A. Connections may (or may not) be depicted between dots 110 of a gesture 120. Connections may be indicated differently depending on whether the connection forms part of the authentication portion 120A or part of the extension portion 120B. Other examples of lock screens will now be discussed with respect to FIGS. 1B and 1C.

Turning now to FIG. 1B, a block diagram of an icon lock screen 100B is depicted. In the illustrated embodiment, icon lock screen 100B is a screen that allows a user to log into a computing device and open a particular application. As shown, lock screen 100B includes a collection of icons 140A-I over which a gesture 150 having an authentication portion 150A and an extension portion 150B may be performed.

Similar to authentication portion 120A discussed above, authentication portion 150A, in one embodiment, is used to authenticate a user. Accordingly, when a user is attempting to authenticate the sequence of icons selected in portion 150A may be compared against those selected previously by an authorized user. For example, if screen 100B is presented on a touch-sensitive display, the user may authenticate by dragging a finger over icons 140A, 140D, 140E, 140H, and 140F as shown in FIG. 1B. As the user selects icons, in various embodiments, screen 100B may indicate the selected icons 140 by displaying connections between icons 140, highlighting selected icons, or performing some other action to indicate selected icons 140.

In the illustrated embodiment, a user selects an application to open upon authentication by extending gesture 150 to that application's icon 140. For example, as shown, performing extension portion 150B to icon 140E corresponding to the music application causes the music application to be opened upon successful verification of authentication portion 150A. In some embodiments, if the user wants to select the icon 140 corresponding to the last icon in authentication portion 150A (e.g., icon 140F corresponding to the Vine™ application in FIG. 1B), the user may perform extension portion 150B by moving off of the icon and back on to the icon, circling the icon, or maintaining pressure on the icon for some period. If the user elects to not perform extension portion 150B then the user may be presented with a default home screen. In some embodiments, an authorized user selects the application icons 140 that are displayed on screen 100B. For example, a user may select the Twitter™ application stored on a smartphone causing icon 140H to be added to screen 100B. In other embodiments, different criteria may be used to determine which icons 140 to display, such as the most recently used applications, most frequently used applications, etc. As with gesture 120, in various embodiments, extension portion 150B may be appended to the beginning or the end of gesture 150 and/or overlap authentication portion 150A.

In some embodiments, the arrangement of icons 140 on screen 100B are periodically altered in order to change the manner in which gesture 150 is performed. For example, icon 140D might be swapped with icon 140B altering performance of gesture 150 such that the user would move right horizontally from icon 140A rather than down vertically as depicted in FIG. 1B. In doing so, a malicious person may be prevented from easily identifying icons included authentication portion 150A from fingerprints or smudges found on a touch-sensitive display presenting screen 100B. In some embodiments, alteration of the depicted arrangement may occur at each login attempt, once a day, or any other suitable interval. In such an embodiment, the arrangement of icons 140 may be selected using a pseudo-random number generator (or some other algorithm).

In some embodiments, screen 100B may be implemented differently than shown in FIG. 1B. For example, in some embodiments, icons 140 may be representative of elements other than applications such as particular files, particular webpages, particular songs, or other content that a user may want to open upon authentication. Still further, although described above as a screen usable to log into a device, screen 100B may also be used to log into an application in some embodiments. In such an embodiment, icons 140 may be representative of particular menus, content, etc. of the application, which the user may want to open upon authentication.

Turning now to FIG. 1C, a block diagram of a PIN lock screen 100C is depicted. As with screens 100A and 100B, in some embodiments, screen 100C may be presented as a login screen for a device, an application, a web service, etc. In the illustrated embodiment, PIN lock screen 100C includes number grid 170 into which a personal identification number (PIN) 180 may be entered. As shown, PIN 180 may include an authentication portion 180A and an extension portion 180B.

Similar to authentication portions 120A and 150A discussed above, authentication portion 180A, in one embodiment, is used to authenticate a user. Accordingly, when a user is attempting to authenticate, the sequence of numbers selected in portion 180A may be compared against those selected previously by an authorized user. For example, if screen 100C is a number pad presented on a touch-sensitive display, the user may authenticate by tapping a finger on the numbers: 1, 4, 9, and 2. As the user selects numbers, in various embodiments, screen 100C may indicate the selected numbers by displaying them above the number pad, highlighting selected numbers.

In some embodiments, a user chooses the particular action to occur upon authentication by extending PIN 180 to include additional elements shown as extension portion 180B. For example, as shown, a user may select the number ‘2’ to extend PIN 180 in order to open the Twitter™ application stored in the smartphone. In some embodiments, the actions taken responsive to an extension portion 180B may be defined by a user—e.g., the user may associate the number ‘2’ with the Twitter™ application. As with the previous figures, in various embodiments, extension portion 180B may be appended to the beginning or the end of PIN 180.

In some embodiments, screen 100C may be implemented differently than shown in FIG. 1C. Accordingly, screen 100C may present alphabet letters or alphanumeric characters instead of merely numbers. These letters may also be associated with particular applications—e.g., the letter ‘T’ appears on screen 100C and represents the Twitter™ application. PIN 180 may include more (or less) characters than shown. In some embodiments, the numbers are presented in a randomized arrangement as discussed above with respect to FIG. 1B.

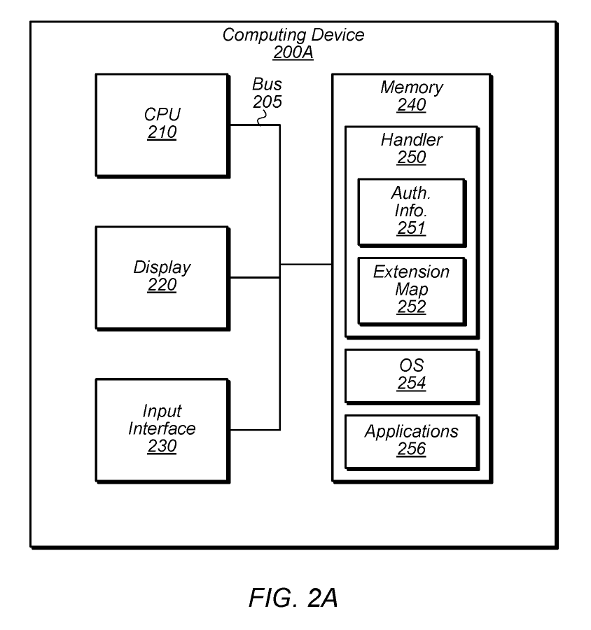

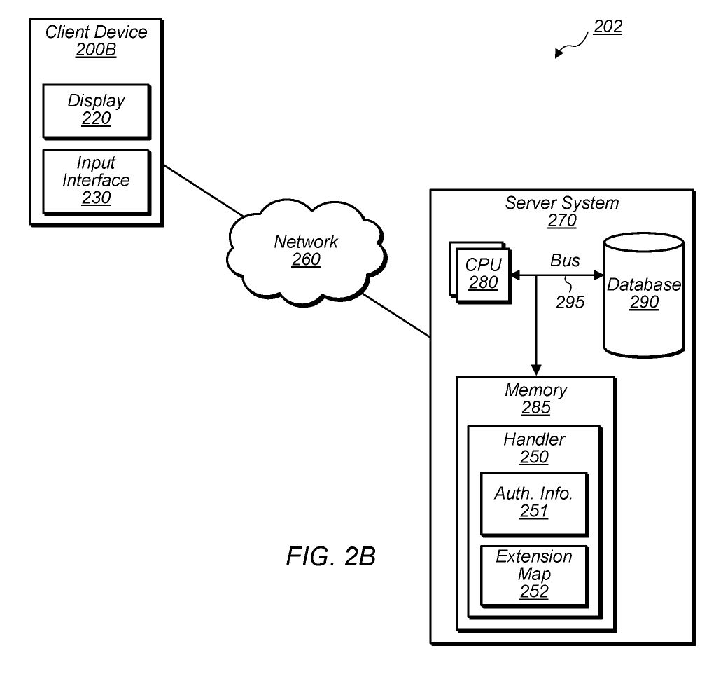

In some embodiments, presentation of a screen 100 A-C and the corresponding authentication are performed by the same computing device (e.g., a user's smartphone) as will be described below with respect to FIG. 2A. In other embodiments, presentation of a screen 100 A-C and authentication are performed by different computing devices (e.g., a client device executing a web browser and a server) as will be described below with respect FIG. 2B.

Turning now to FIG. 2A, a block diagram of a computing device 200A configured to present a lock screen 100 and authenticate a user is depicted. Computing device 200A may be any suitable form of computing device such as a mobile device, a desktop computer, laptop, etc. In the illustrated embodiment, the computing device 200A includes a bus 205 connecting a central processing unit (CPU) 210, a display 220, an input interface 230, a memory 240. Memory 240 includes a handler 250, an operating system (OS) 254, and applications 256. Handler 250 includes authentication information 251 and an extension map 252. In some embodiments, computing device 200A is implemented differently than shown.

CPU 210, in one embodiment, is a processing unit configured to execute program instructions stored in a non-transitory computer readable medium such as memory 240 in order to implement functionality described herein. CPU 210 may include multiple processor cores, which may each be multi-threaded. In some embodiments, CPU 210 is configured to perform techniques to improve efficiency such as super-threading, hyper-threading, virtualization, and the like. Furthermore, CPU 210 may include specialized hardware for encrypting and decrypting files using AES encryption (or any known form of encryption/decryption). In various embodiments, CPU 210 uses a cache hierarchy that includes an L1 cache and an L2 cache.

Display 220, in one embodiment, is an interface configured to present content to a user such as one of screens 100A-100C. Display 220 may be any suitable form of display such as a liquid crystal display (LCD), a light-emitting diode display (LED), a plasma display panel (PDP), or the like. In some embodiments, display 220 is a touch-sensitive display configured to implement functionality of input interface 230.

Input interface 230, in one embodiment, is an interface configured to receive input from a user such as a gesture 120, gesture 150, or PIN 180. Although various examples have been given with regards to a touch-sensitive display, input interface 230 may be any suitable form of interface such as a mouse, keyboard, joystick, stylus, camera, etc. For example, instead of drawing gesture 120 using a finger, a user may draw gesture 120 holding down a mouse button and moving a pointer over dots 110.

Memory 240, in one embodiment, is a non-transitory computer readable medium configured to store program instructions executable to implement functionality described herein such as program instructions for handler 250, OS 254, and/or applications 256. Memory 240 may be implemented using any suitable form of physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on.

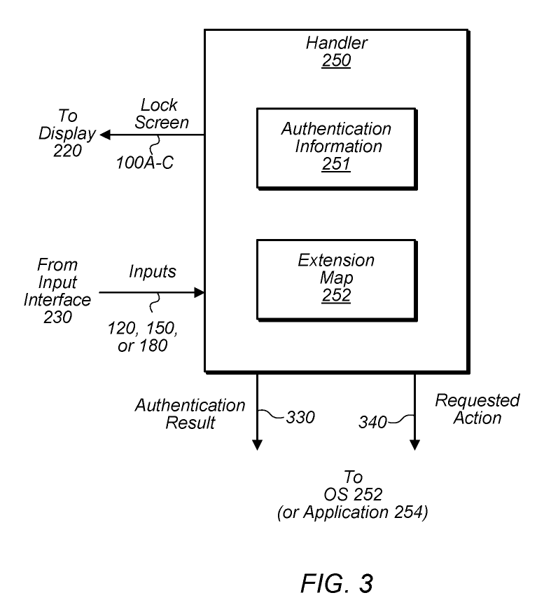

Handler 250, in one embodiment, is a set of program instructions executable to implement functionality described herein with respect to screens 100A-100C. Accordingly, as will be described in greater detail below with respect to FIG. 3, handler 250 may be executable to present a screen 100, authenticate a user based on the user's input into interface 230, and/or determine whether an extension portion 120B, 150B, or 180B is present. In the various embodiments, handler 250 maintains authentication information 251 in order to perform user authentications. This information 251 may include information about gestures 120, gestures 150, or PINs 180 previously performed by authorized users and used to perform a comparison of a newly received input 120, 150, or 180 and a previously performed one by an authorized user. In some embodiments, information 251 may include a hash value calculated from information about a particular input 120, 150, and 180 such as a hash value calculated based on the sequence of dots 110A-E as shown in FIG. 1A. In various embodiments, handler 250 also maintains an extension map 252 that indicates what is to be performed (e.g., what application, file, menu is to be opened as discussed above) when a particular extension portion 120B, 150B, or 180B is performed by a user. In some embodiments, map 252 is generated based on selections made by a user—e.g., a user selecting which icons 140 appear in screen 100B. In other embodiments, handler 250 may determine map 252 based on one or more criteria such as the most frequently used applications, most recently used applications, etc.

OS 254, in one embodiment, is an operating system executable to manage various aspects of computing device 200A including controlling access to device 200A. In various embodiments, handler 250 interfaces with OS 254 (or is even a part of OS 254) in order to facilitate authenticating a user requesting access to device 200A. Accordingly, in response to receiving an indication that a user desires to access device 200A, handler 250 may generate a lock screen 100 and request that OS 254 cause display 220 to present the lock screen 100 to the user. OS 254 may collect information from interface 230 about an input 120, 150, or 180 and present this information to handler 250 to authenticate a user and determine whether an extension portion 120B, 150B, or 180B has been performed. Handler 250 may then instruct OS 254 to unlock a device 200A in response to a successful authentication and perform a particular action corresponding to the performed extension portion 120B, 150B, or 180B.

Applications 256, in one embodiment, are various applications, which may be installed on device 200A or accessible from device 200A. In an embodiment in which a lock screen 100 is presented to access device 200A, execution of applications 256 may be initiated in response to performance of an extension portion 120B, 150B, or 180B. Accordingly, applications 256 may correspond to the icons 140A-I depicted in FIG. 1B, for example. In other embodiments, an application 256 may present a lock screen 100 in order to authenticate a user attempting to gain access to the application 256. In such an embodiment, handler 250 may be integrated within the application 256 (or interface with application 256). Accordingly, application 256 may request display 220 to present a screen 100 provided by handler 250 and request that handler 250 verify a user's input 120, 150, or 180. Handler 250 may indicate the result of this verification along with providing an instruction to application 256 indicating what application 256 is to perform responsive to a successful authentication. As noted above, this may include instructing application 256 to open a particular menu, provide access to a particular content, perform a particular action, etc. For example, performing a particular extension portion for a music application 256 may cause handler to instruct that application 256 to begin playing a particular song.

Turning now to FIG. 2B, a block diagram of a computer system 202 in which a client presents a lock screen for a server handling authentication is depicted. In the illustrated embodiment, system 202 includes a client device 200B and a server system 270, which communicate over a network 260. As shown, client 200B includes a display 220 and an input 230. Server system 270, in turn, includes a CPU 280, memory 285 including handler 250, and database 290 coupled together via a bus 295. In some embodiments, system 270 may be implemented differently than shown.

As with discussed above with computing device 200A, in one embodiment, client device 200B is configured to present a lock screen 100 via display 220 and collect information about an input 120, 150, or 180 via input interface 230. Rather than perform authentication, client device 200B, in the illustrated embodiment, communicates collected information over network 260 to server system 270, which may perform authentication via handler 250. As discussed above, in some embodiments, this information may be collected to facilitate obtaining access to client device 200B. In other embodiments, this information may be collected to facilitate accessing an application, which may be located at device 200B or at server system 270 as descried below. Client device 200B may correspond to any suitable computing device such as those listed above with respect to computing device 200A.

Network 260 may be any suitable form of computer network, which allows a client device 200B and a server system 270 to exchange data. Accordingly, network 260 may include a combination of wired and wireless technologies that include optical fiber, Ethernet, cellular, radio, and the like. Network 260 may be implemented through bridges, repeaters, switches, routers, modems, and firewalls. Network 260 may be a local area network, wide area network, enterprise private network, virtual private network, and/or the like.

Server system 270, in one embodiment, is configured to authenticate a user and determine whether an extension portion 120B, 150B, or 180B is present in a received input 120, 150, or 180. In the illustrated embodiment, server system 270 implements this functionality by executing handler 250 on CPU 280. In various embodiments, server system 270 also provides one or more services accessible to a user of client device 200B responsive to a successful authentication via a lock screen 100. For example, server system 270 may use database 290 to implement a database server, a file server, a mail server, a print server, a web server, a game server, and/or an application server. In some embodiments, these services may be accessible to an application executing on client device 200B. For example, a banking application executing on device 200B may retrieve an account balance stored in database 290 in response to a successful authentication of a user and an extension portion 120B, 150B, or 180B being provided to request display of the account balance. In other embodiments, these services may be accessible be an application executing on server system 270. For example, a user may log into a banking website via a browser executing on client device 200B, and server system 270 may present an account balance stored in database 290 in response to a successful authentication of a user and an extension portion 120B, 150B, or 180B requesting display of the account balance. In some embodiments, functionality provided by server system 270 may be provided as part of a software as a service (SaaS). For example, in some embodiments, server system 270 may deliver an application to client devices 200B that uses an authentication service provided by server system 270. In some embodiments, system 270 may provide access to content, such as virtual machine executing on server system 270.

Turning now to FIG. 3, a block diagram of handler 250 is depicted. As noted above, in various embodiments, handler 250 is responsible for presenting a lock screen 100, authenticating a user, and/or requesting performance of an action in response to any provided extension portion 120B, 150B, or 180B. Accordingly, in the illustrated embodiment, handler 250 presents a lock screen 100 to display 220 and receives a corresponding input 120, 150, or 180 from input interface 230. Based on the received input, handler 250 may indicate an authentication result 330 and a requested action 340, which may be presented to OS 254 or application 256.

In processing a received input 120, 150, or 180, handler 250 may perform any of various suitable techniques to perform a comparison for an input in order to authenticate a user. For example, in one embodiment, authentication information 251 may include a string identifying the locations of elements on a screen that are selected by an authorized user in an authentication portion 120A, 150A, or 180A. In response to receiving an access request specifying an input 120, 150, or 180, handler 250 compares this string with a string identifying selected elements in the authentication portion of the input 120, 150, or 180. In another embodiment, authentication information 251 includes a hash value calculated from locations of elements selected by an authorized user in an authentication portion 120A, 150A, or 180A. In response to receiving an access request including an input 120, 150, or 180, handler 250 may compute a corresponding hash value from the authentication portion 120A, 150A, or 180A and compare that hash value with the hash value included in authentication portion 251. Handler 250 may perform any suitable hashing algorithm such as any member of the secure hash algorithm (SHA) family, the BLAKE2 algorithm, or the MD5 algorithm. In some embodiments, authentication information 251 may include information associated with several distinct users.

Handler 250 may also employee any of various techniques to discern the existence of an extension portion 120B, 150B, or 180B in an input 120, 150, or 180. In one embodiment, authentication information 251 may include the length of an authentication portion 120A, 150A, or 180A; thus, handler 250 may determine whether an extension portion 120B, 150B, or 180B exists when in input 120, 150, or 180 exceeds the length. In another embodiment, handler 250 may identify an extension portion 120B, 150B, or 180B in response to detecting that a user has paused between performing an authentication portion and an extension portion. In response to detecting that an extension portion 120B, 150B, or 180B exists, handler 250 may examine extension map 252 to determine the appropriate action to take based on the performed extension portion. If the authentication is successful, handler 250 may indicate the successful authentication via a result 300 and identify the requested action 340 based on the appropriate action indicated map 252.

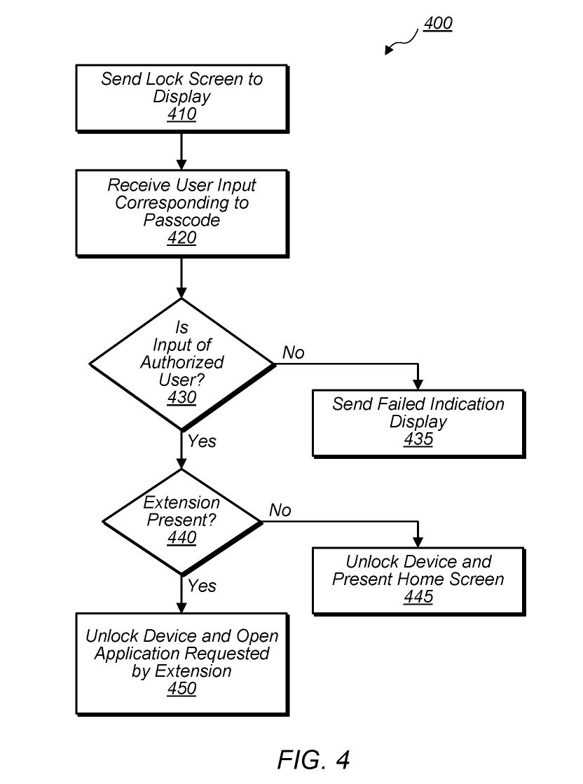

Turning now to FIG. 4, a flow diagram of a method 400 is depicted. Method 400 is one embodiment of a method performed by a computer system (such as computing device 200A, client device 200B, server system 270, or a combination thereof executing handler 250) to authenticate a user. In many instances, performance of method 400 allows a user to more quickly authenticate and open an application (or menu, file, application content) than an approach that relied on navigating a home screen to open an application. In some embodiments, the steps of method 400 may be performed in a different order—e.g., step 440 may be performed before step 430.

Method 400 begins in step 410 with a lock screen (e.g., one of screens 100A-C) being sent to a display (e.g., display 220), which displays the screen to a user. In step 420, a user input (e.g., one inputs 120, 150, or 180) is received corresponding to a passcode. In step 430, a determination is made whether the input is of an authorized user. In some embodiments, step 430 includes comparing a portion of the input (e.g., an authorization portion 120A, 150A, or 180A) with an input previously provided by an authorized user. If the input is not of an authorized user, method 400 proceeds to step 435 where an indication of a failed authentication is sent to the display. Otherwise, method 400 proceeds to step 440 where a determination is made whether an extension is present in the input (e.g., an extension portion 120B, 150B, or 180B). If an extension is not present, a computing device is unlocked and a home screen is presented at step 445. If an extension is present, the computing device is unlocked an application requested by the extension is opened on the device at step 450.

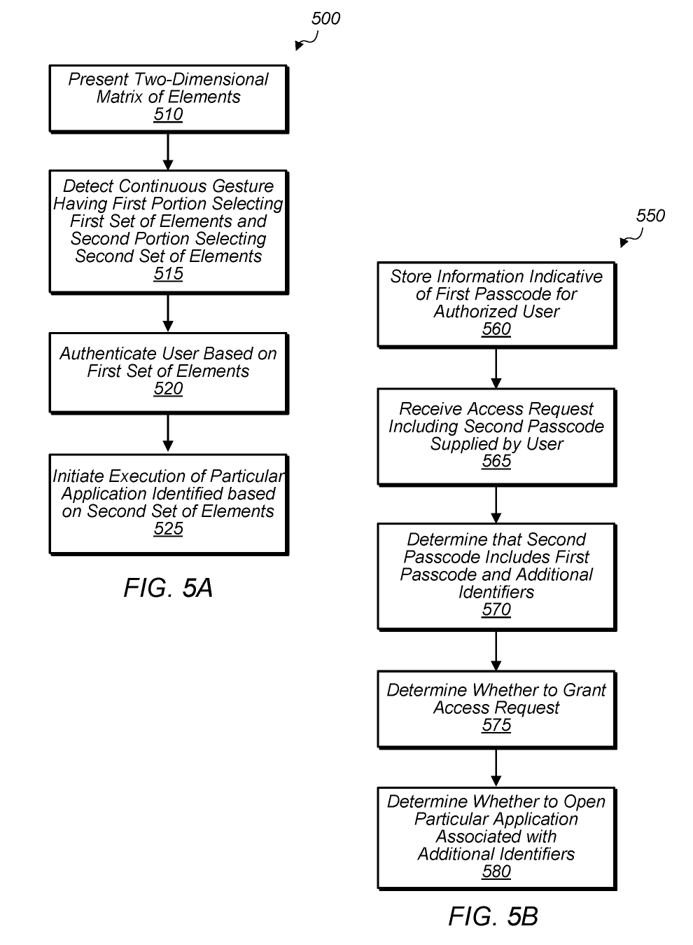

Turning now to FIG. 5A, a flow diagram of a method 500 is depicted. Method 500 is one embodiment of a method for authenticating a user and is performed by a computing device such as one executing handler 250. In some embodiments, steps of method 500 may be performed in a different order than shown or concurrently.

In step 510, a two-dimensional matrix of elements (e.g., dots 110, icons 140, or numbers in grid 170) is presented on a display of the computing device (e.g., display 220). In some embodiments, step 510 includes using a pseudo random number generator to select an ordering for elements in the two-dimensional matrix and presenting the elements in the selected ordering in the two-dimensional matrix.

In step 515, a continuous gesture performed by the user on the display over the two-dimensional matrix of elements is detected. The gesture may include a first portion of a first set of selected elements (e.g., authentication portion 120A, 150A, or 180A) and second portion of a second set of selected elements (e.g., extension portion 120B, 150B, or 180B). In some embodiments, step 515 includes identifying a transition from the first portion of the gesture to the second portion of the gesture by detecting a pause in movement of the user's finger. In one embodiment, the first portion is a beginning portion of the gesture, and the second portion is an ending portion of the gesture.

In step 520, the user is authenticated based on the selected first set of elements. In some embodiments, step 520 includes comparing the selected first set of elements with a third set of elements (e.g., as indicated by authentication information 251) selected by a gesture performed by an authorized user of the computing device. In some embodiments, step 520 includes calculating a first hash value based on locations of the first set of elements in the two-dimensional matrix, calculating a second hash value based on locations of the third set of elements in the two-dimensional matrix, and comparing the first and second hash values.

In step 525, execution of a particular application identified based on the second set of elements is initiated. In some embodiments, the elements include icons for applications executable by the computing device, and the second set of elements includes an icon for the particular application.

Turning now to FIG. 5B, a flow diagram of a method 550 is depicted. Method 550 is another embodiment of a method performed by a computer system such as one executing handler 250. Method 550 begins in step 560 with the computer system storing information (e.g., authentication information 251) indicative of a first passcode for an authorized user (e.g., an authentication portion 120A, 150A, or 180A), the passcode including a plurality of identifiers (e.g., selected dots 110, icons 140, numbers in grid 170). In step 565, the computer system receives an access request from a user via an interface (e.g., input interface 230). In some embodiments, the access request includes a second passcode (e.g., an input 120, 150, or 180) supplied by the user. In step 570, the computer system determines that the second passcode (e.g., an input 120, 150, or 180 received via interface 230) includes the first passcode (e.g., an authentication portion 120A, 150A, or 180A) and one or more additional identifiers (e.g., selected dots 110, icons 140, or numbers in grid 170 in an extension portion 120B, 150B, or 180B). In some embodiments, the one or more additional identifiers are associated with a particular application. In response to the determination in step 570, the computer system determines whether to grant the access request in step 575 and determines whether to open the particular application in step 580. In some embodiments, steps of method 550 may be performed in a different order than shown or concurrently.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having program instructions stored thereon are executable to cause a computing device to perform operations comprising:
presenting a two-dimensional matrix of elements on a display of the computing device;
detecting a continuous gesture performed by a user on the display over the two-dimensional matrix of elements, wherein the gesture includes a first portion selecting a first set of the elements and a second portion selecting a second set of the elements;
in response to the detecting:
authenticating the user based on the selected first set of elements; and
initiating execution of a particular application identified based on the second set of elements.

2. The computer readable medium of claim 1, wherein the authenticating includes:
comparing the selected first set of elements with a third set of elements selected by a gesture performed by an authorized user of the computing device.

3. The computer readable medium of claim 2, wherein the comparing includes:
calculating a first hash value based on locations of the first set of elements in the two-dimensional matrix;
calculating a second hash value based on locations of the third set of elements in the two-dimensional matrix; and
comparing the first and second hash values.

4. The computer readable medium of claim 1, wherein the elements include icons for applications executable by the computing device, and wherein the second set of elements includes an icon for the particular application.

5. The computer readable medium of claim 4, wherein the operations further comprise:
use a pseudo random number generator to select an ordering for elements in the two-dimensional matrix; and
present the elements in the selected ordering in the two-dimensional matrix.

6. The computer readable medium of claim 4, wherein the operations further comprise:
requesting that the user select one or more applications for inclusion in the two-dimensional matrix; and
presenting the two-dimensional matrix having icons of the selected one or more applications.

7. The computer readable medium of claim 1, wherein the operations further comprise:
identifying a transition from the first portion of the gesture to the second portion of the gesture by detecting a pause in movement of the user's finger.

8. The computer readable medium of claim 1, wherein the first portion is a beginning portion of the gesture, and wherein the second portion is an ending portion of the gesture.

9. A method, comprising:
storing, by a computer system, information indicative of a first passcode for an authorized user, wherein the passcode includes a plurality of identifiers;
receiving, by the computer system, an access request from a user via an interface, wherein the access request includes a second passcode supplied by the user;
determining, by the computer system, that the second passcode includes the first passcode and one or more additional identifiers, wherein the one or more additional identifiers are associated with a particular application; and
in response to the determining:
determining, by the computer system, whether to grant the access request; and
determining, by the computer system, whether to open the particular application.

10. The method of claim 9, further comprising:
storing, by the computer system, a mapping associating identifiers to one or more respective applications, wherein the mapping includes an entry associating the one or more additional identifiers to the particular application; and
based on the entry, determining, by the computer system, to open the particular application in response to the one or more additional identifiers being included in the second passcode, and wherein the one or more additional identifiers are appended to an end of the second passcode.

11. The method of claim 9, further comprising:
providing, by the computer system, a lock screen having a plurality of icons representative of applications stored on a computing device associated with the user; and
wherein the receiving includes receiving a sequence of selected ones of the plurality of icons as the second passcode, and wherein the plurality of identifiers are the icons selected by the user.

12. The method of claim 11, further comprising:
using, by the computer system, a pseudo random generator to determine an order to display the plurality of icons on the lock screen; and
causing, by the computer system, the plurality of icons to be displayed in accordance with the determined order.

13. The method of claim 9, wherein the storing includes:
calculating, by the computer system, a first hash value of the first passcode; and
storing, by the computer system, the first hash value and a length of the first passcode.

14. The method of claim 13, wherein the determining that the second passcode includes the first passcode and one or more additional identifiers includes:
in response to determining that the second passcode exceeds the stored length of the first passcode:
calculating, by the computer system, a second hash value for a subset of identifiers in the second passcode, wherein the subset has the length of the first passcode and does not include the one or more additional identifiers;
comparing, by the computer system, the first hash value with the second hash value to determine whether access is to be provided to the computer system; and
determining, by the computer system, whether the one or more additional identifiers are associated with an application to be opened.

15. The method of claim 9, wherein the plurality of identifiers includes a sequence of alphanumeric characters, wherein the determining whether to open the particular application includes determining whether to open a portion of the particular application.

16. A non-transitory computer readable medium having program instructions stored thereon that are executable to cause a computing device to perform operations comprising:
presenting a display having a two-dimensional arrangement of icons associated with applications executable by the computing device;
detecting a gesture performed over the two-dimensional arrangement of icons, wherein the gesture identifies ones of the icons in a particular ordering; and
in response to the detecting:
determining whether to grant access to the computing device based on the identified icons in the particular ordering; and
opening an application based on one of the identified icons.

17. The computer readable medium of claim 16, wherein the operations further comprise:
presenting a display having a first two-dimensional arrangement of the icon during a first attempt to authenticate a user; and
presenting a display having a second two-dimensional arrangement of the icons during a second attempt to authenticate a user, wherein the first arrangement differs from the second arrangement.

18. The computer readable medium of claim 16, wherein the determining includes:
sending the identified icons in the particular ordering to a computer system separate from the computing device; and
receiving an indication of a result of a comparison performed by the computer system, wherein the indication specifies a match between a portion of the identified icons and a second portion of icons.

19. The computer readable medium of claim 16, wherein the operations further comprise:
storing a first hash value determined based on icons identified by a gesture of an authorized user; and
determining whether to grant access to the computing device by:
determining a second hash value based on icons identified by the detected gesture; and
comparing the first hash value with the second hash value.

20. The computer readable medium of claim 16, wherein the opened application corresponds to an initial icon or a last icon identified by the gesture.
